(19) United States
(12) Patent Application Publication
(10) Pub. No.: US 2010/0098166 A1
(43) Pub. Date: Apr. 22, 2010

(54) VIDEO CODING WITH COMPRESSED REFERENCE FRAMES

(75) Inventors: Madhukar Budagavi, Plano, TX (US); Minhua Zhou, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/552,139

(22) Filed: Sep. 1, 2009

Related U.S. Application Data
(60) Provisional application No. 61/106,179, filed on Oct. 17, 2008.

(51) Int. Cl. H04N 7/26; H04N 11/02

(52) U.S. Cl. 375/240.16; 375/240.23; 375/E07.033; 375/E07.104; 375/E07.164

(57) ABSTRACT

A method and apparatus for video coding for reducing memory size and external memory access bandwidth in video coding, wherein the method compresses a reference frame prior to storing the reference frame to memory.

### CROSS-REFERENCE TO RELATED APPLICATIONS

This application claims priority from provisional application Nos. 61/106,179, filed on Oct. 18, 2008, which is herein incorporated by reference.

### BACKGROUND

The present invention relates to digital video signal processing, and more particularly to devices and methods for video coding.

There are multiple applications for digital video communication and storage, and multiple international standards for video coding have been and are continuing to be developed. Low bit rate communications, such as, video telephony and conferencing, led to the H.261 standard with bit rates as multiples of 64 kbps, and the MPEG-1 standard provides picture quality comparable to that of VHS videotape. Subsequently, H.263, MPEG-2, and MPEG-4 standards have been promulgated.

H.264/AVC is a recent video coding standard that makes use of several advanced video coding tools to provide better compression performance than existing video coding standards. At the core of all of these standards is the hybrid video coding technique of block motion compensation (prediction) plus transform coding of prediction error. Block motion compensation is used to remove temporal redundancy between successive pictures (frames or fields) by prediction from prior pictures, whereas transform coding is used to remove spatial redundancy within each block of both temporal and spatial prediction errors. FIG. 2a-2b illustrate H.264/AVC functions which include a deblocking filter within the motion compensation loop to limit artifacts created at block edges.

Traditional block motion compensation schemes basically assume that between successive pictures an object in a scene undergoes a displacement in the x- and y-directions and these displacements define the components of a motion vector. Thus an object in one picture can be predicted from the object in a prior picture by using the object's motion vector. Block motion compensation simply partitions a picture into blocks and treats each block as an object and then finds its motion vector which locates the most-similar block in a prior picture (motion estimation). This simple assumption works out in a satisfactory fashion in most cases in practice, and thus block motion compensation has become the most widely used technique for temporal redundancy removal in video coding standards. Further, periodically pictures coded without motion compensation are inserted to avoid error propagation; blocks encoded without motion compensation are called intra-coded, and blocks encoded with motion compensation are called inter-coded.

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264/AVC. The residual (prediction error) block can then be encoded (i.e., block transformation, transform coefficient quantization, entropy encoding). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264/AVC uses an integer approximation to a 4×4 DCT for each of sixteen 4×4 Y blocks and eight 4×4 chrominance blocks per macroblock. Thus an inter-coded block is encoded as motion vector(s) plus quantized transformed residual block.

Similarly, intra-coded pictures may still have spatial prediction for blocks by extrapolation from already encoded portions of the picture. Typically, pictures are encoded in raster scan order of blocks, so pixels of blocks above and to the left of a current block can be used for prediction. Again, transformation of the prediction errors for a block can remove spatial correlations and enhance coding efficiency.

The rate-control unit in FIG. 2a is responsible for generating the quantization step (qp) by adapting to a target transmission bit-rate and the output buffer-fullness; a larger quantization step implies more vanishing and/or smaller quantized transform coefficients which means fewer and/or shorter codewords and consequent smaller bit rates and files.

However, portable video devices such as camera phones, digital still cameras, personal media players, etc. have become very popular and their annual shipments are expected to grow very rapidly. Battery life is one of the key concerns for portable video devices. Power consumed in a video codec depends on computational complexity, memory size, and memory bandwidth. So techniques for reducing memory size and memory bandwidth are important in addition to reducing computational complexity in the video codec.

Memory bandwidth is one of the key limiting factors for motion estimation in high-definition (HD) video coding. Memory bandwidth typically determines the motion vector search range in video codecs with hardware accelerators and hence it impacts resulting video quality. Techniques that reduce memory bandwidth during motion estimation are desirable for reducing cost and power and for increasing quality in HD video solutions.

### SUMMARY OF THE INVENTION

The present invention provides for a method and apparatus for video coding for reducing memory size and external memory access bandwidth in video coding, wherein the method compresses a reference frame prior to storing the reference frame to memory

### BRIEF DESCRIPTION OF THE DRAWINGS

FIG. 1a-1b illustrated preferred embodiment coding with reference frame compression and decompression within the video coding loop.

FIG. 2a-2b show video coding functional blocks.

FIG. 3a-3b illustrate a processor and packet network communication.

### DESCRIPTION OF THE PREFERRED EMBODIMENTS

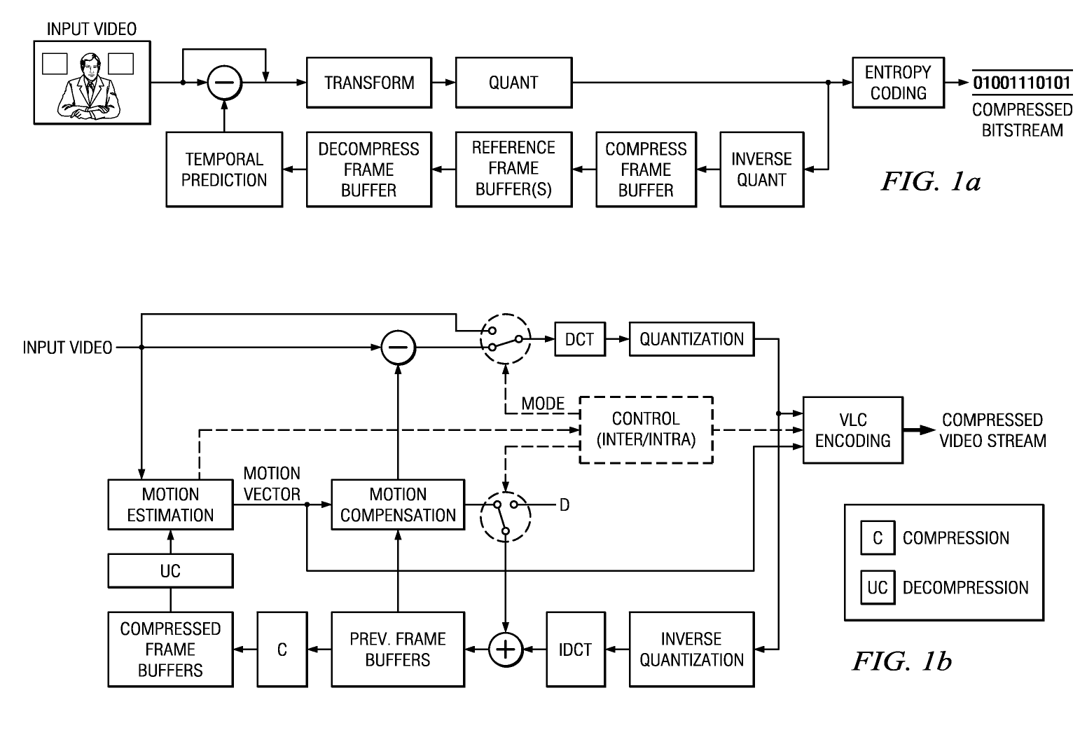

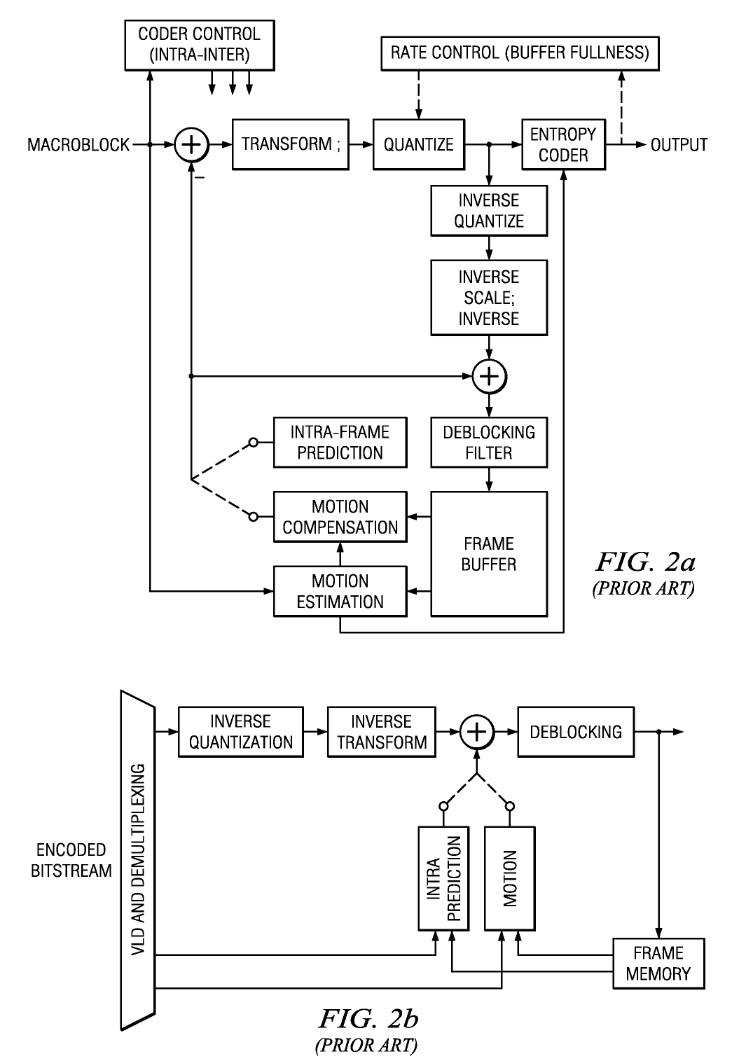

Preferred embodiment video coding methods provide reduced reference frame buffer memory size and external memory access bandwidth in video coding and include compressing the reference frames before storing them in memory by: (1) Using fixed-length compression (FLC) to compress reference frames in order to maintain random access for any block of pixels in memory and (2) Carrying out reference frame compression in the core video coding loop so that quantization errors encountered during FLC show up in the residual after motion compensation thereby preventing drift between the encoder and the decoder; see FIG. 1a-1b.

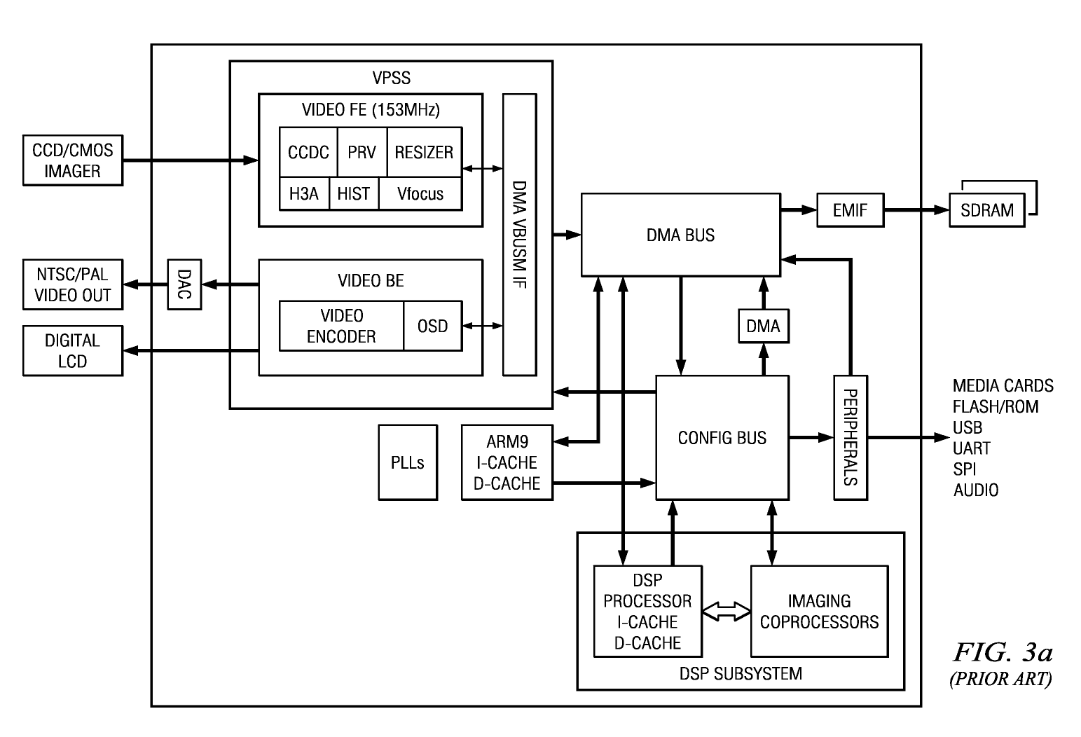

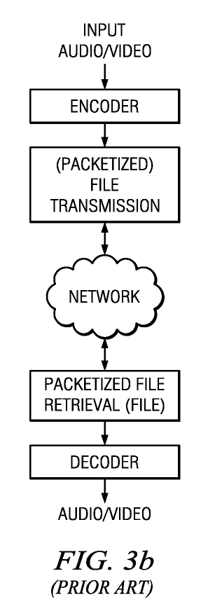

Preferred embodiment systems (e.g., camera phones, PDAs, digital cameras, notebook computers, etc.) perform preferred embodiment methods with any of several types of hardware, such as digital signal processors (DSPs), general purpose programmable processors, application specific circuits, or systems on a chip (SoC) such as multicore processor arrays or combinations such as a DSP and a RISC processor together with various specialized programmable accelerators (e.g., FIG. 3a). A stored program in an onboard or external (flash EEP)ROM or FRAM could implement the signal processing methods. Analog-to-digital and digital-to-analog converters can provide coupling to the analog world; modulators and demodulators (plus antennas for air interfaces such as for video on camera phones) can provide coupling for transmission waveforms; and packetizers can provide formats for transmission over networks such as the Internet as illustrated in FIG. 3b.

FIG. 1a-1b show preferred embodiment methods incorporated into the traditional video coding algorithm of motion compensation transform coding. The reference frames are compressed before being stored in memory and they are decompressed before being read from the memory. Two features are: (1) Using fixed-length compression (FLC) to compress reference frames in order to maintain random access of any block of pixels in memory. (2) Carrying out reference frame compression in the core video coding loop so that quantization errors encountered during FLC show up in the residual after motion compensation thereby preventing drift between the encoder and the decoder. Various compression methods could be used, such as MMSQ described in the next section, or more complex compression techniques such as Entropy coded quantization, ADPCM, and VQ.

The MMSQ preferred embodiment compresses the reference frame and stores it in SDRAM. During motion estimation, read the compressed data from SDRAM and decompress it into on-chip memory before using it for motion estimation. The min/max scalar quantization (MMSQ) compression method is a fixed-length compression. Fixed-length compression allows for random access of memory blocks which is useful in motion estimation. Our MMSQ fixed-length compression scheme operates on 4×4 pixel blocks. We calculate the minimum and maximum pixel values for each block and uniformly quantize all the pixels in the 4×4 block to be between the minimum and maximum pixel values. Data that is stored for each block of 4×4 pixels consists of the minimum and maximum pixel values of the block (the minimum and maximum values are stored with 8 bits each) and the scalar quantized indices for each pixel (16 indices in total).

A preceding preferred embodiment method uses a block scalar quantization scheme for compressing the reference frames. This operates on 4×4 pixel blocks. For each pixel block, we calculate the minimum and maximum pixel values and store it. Then we uniformly quantize all the pixels in the 4×4 block to lie between the calculated minimum and maximum pixel values and store them. This generates fixed number of bits for each block that is compressed. Fixed-length coding is desirable in motion compensation because motion vectors in video coding standards can point to anywhere in the picture.

However, variable length compression (VLC) usually provides a better compression ratio when compared to fixed length coding. Variable length coding usually involves a combination of one or more of the following components: transforms, prediction, quantization, and entropy coding. When VLC is used, random access at block level becomes difficult because of the variable length nature of the coding. A table of coded block lengths would then be required to achieve random access at block level. This table would have to be read first before doing any memory access. This would impose a signification overhead on memory accesses. We overcome this problem by constraining random access to be at a macroblock row level in which case only a table of macroblock row lengths needs to be stored thereby reducing the overhead involved in memory accesses significantly.

Constraining random access to be only at macroblock row level requires having enough internal memory to store multiple rows of macroblocks. The number of rows of macroblocks that needs to be stored in the encoder depends on the vertical motion vector search range. A new row of macroblocks is loaded in the encoder when ME of the leftmost macroblock of that row is carried out. The oldest row of macroblock is discarded. This results in a sliding window of rows of macroblocks. In the decoder, the issue is more complicated when variable length coding is adopted since the motion vector can point to any location in memory. Two alternative preferred embodiment methods each takes care of the problem:
1. Restrict vertical motion vector range in the encoder so that using a sliding macroblock rows window approach becomes possible in the decoder too by using enough internal memory. This is the preferred approach since it leads to memory bandwidth reduction in both the encoder and the decoder.
2. Impose no restriction on vertical motion vector range: Compression of reference frames is carried out such that there is no dependency between blocks of pixels. The encoder uses variable length coding of blocks of pixels. The decoder emulates the coding of block of pixels (such as carrying out any quantization done in the encoder) and regenerates the reference frames used in the encoder. The regenerated reference frames can be stored in the uncompressed form in the decoder. Alternatively, the emulation of the encoder operation on block of pixels can be carried out on the fly in the decoder—the reference frames can then be stored in the original form (before frame buffer compression) in the decoder. In this case, the memory bandwidth savings are in the encoder only.

Any variable length compression scheme can be used to implement variable length compression of reference frames. Some example compression schemes are provided below: (entropy coding refers to any one or combination of the following: exp-Golomb coding, Huffman coding, or arithmetic coding).
DPCM/ADPCM+entropy coding
Block scalar quantization+DPCM between blocks+entropy coding
Entropy constrained vector quantization
Block transforms (such as simple Hadamard transform or DCT)+Quantization+entropy coding.

The block size can be variable. We used blocks of 4×4 in our experimentation.

We investigated two fixed-length compression schemes of the first preferred embodiments, the details of which are provided below:

FLC1: For representing each 4×4 block, 8-bits used for minimum pixel value (per block), 8-bits are used for maximum pixel value (per block), pixels in the block are uniformly quantized to lie in the [minimum, maximum] range by using 4 bits per pixel. So overall, to represent a 4×4 block, we require 5 bits/pixel. This leads to a 37.5% savings in memory size used to store reference frames.

FLC2: For representing each 4×4 block, 8-bits are used for minimum pixel value (per block), 8-bits are used for maximum pixel value (per block), pixels in the block are uniformly quantized to lie in the [minimum, maximum] range by using 3 bits per pixel. So overall, to represent a 4×4 block, we require 4 bits/pixel. This leads to a 50% savings in memory size used to store reference frames.

The table below shows the results of using FLC1 and FLC2 on typical video sequences at D1 resolution. FLC1 requires 37.5% less memory when compared to H.264 but incurs a 0.4-2.7% increase in bitrate and 0.01-0.12 dB decrease in PSNR. FLC2 requires 50% less memory when compared to H.264 but incurs a 2.2-12.65% increase in bitrate and 0.05-0.37 dB decrease in PSNR.

| | | | | | PSNR-Y | | |
|---|---|---|---|---|---|---|---|
| | | | % increase | | decrease | | |
| | | P-frame | in P-frame | | compared | | |
| | Bitrate | bits | bits | PSNR-Y | to H.264 | PSNR-U | PSNR-V |
| Football (H.264) | 3400.39 | 16887760 | | 36.33 | | 41.16 | 42.55 |
| Football (H.264, FLC1) | 3413.6 | 16953776 | 0.39% | 36.32 | 0.01 | 41.15 | 42.56 |
| Football (H.264, FLC2) | 3475.68 | 17264200 | 2.23% | 36.28 | 0.05 | 41.15 | 42.56 |
| HarryPotter (H.264) | 1884.66 | 9260936 | | 37.49 | | 40.91 | 42.58 |
| HarryPotter (H.264, FLC1) | 1934.63 | 9510792 | 2.70% | 37.37 | 0.12 | 40.9 | 42.56 |
| HarryPotter (H.264, FLC2) | 2118.97 | 10432528 | 12.65% | 37.12 | 0.37 | 40.86 | 42.53 |
| Ice (H.264) | 959.59 | 7521216 | | 40.07 | | 45.71 | 45.76 |
| Ice (H.264, FLC1) | 981.38 | 7694840 | 2.31% | 39.97 | 0.1 | 45.75 | 45.74 |
| Ice (H.264, FLC2) | 1071.97 | 8416536 | 11.90% | 39.79 | 0.28 | 45.67 | 45.63 |
| Soccer (H.264) | 2325.37 | 19364928 | | 36.59 | | 43 | 44.89 |
| Soccer (H.264, FLC1) | 2358.3 | 19644888 | 1.45% | 36.55 | 0.04 | 42.99 | 44.86 |
| Soccer (H.264, FLC2) | 2495.05 | 20807192 | 7.45% | 36.44 | 0.15 | 43 | 44.87 |
| Starwars (H.264) | 297.87 | 935960 | | 41.59 | | 45.14 | 45.74 |
| Starwars (H.264, FLC1) | 303.78 | 955640 | 2.10% | 41.52 | 0.07 | 45.19 | 45.72 |
| Starwars (H.264, FLC2) | 329.05 | 1039904 | 11.11% | 41.35 | 0.24 | 45.17 | 45.68 |

Table 2 below shows the rate-distortion performance of our min/max scalar quantization scheme (MMSQ) on 10 D1 video sequences. From the table, we can see that the MMSQ technique provides a relatively high average PSNR value of 38.44 dB at even 4 bits per pixel. Hence we anticipate that there will be little degradation in PSNR and bitrate when we use the MMSQ technique for quantizing the reference frames in the motion estimation stage.

TABLE 2
Rate-distortion performance of MMSQ. Table lists PSNR-Y values at various bits-per-pixel.

| | | Min-max, | Min-max, | Min-max, | Min-max, |
|---|---|---|---|---|---|
| | | Scalar Q, | Scalar Q, | Scalar Q, | Scalar Q, |
| | | 3 bpp | 4 bpp | 5 bpp | 6 bpp |
| | Num | (PSNR | (PSNR | (PSNR | (PSNR |
| Sequence | Frames | dB) | dB) | dB) | dB) |
| football_p704x480 | 150 | 32.969264 | 39.749282 | 45.983451 | 51.984504 |
| harryPotter_p720x480 | 150 | 31.285029 | 37.884567 | 44.101559 | 50.028192 |
| ICE_704x576_30_orig_02 | 239 | 33.883506 | 39.011147 | 44.210051 | 49.763217 |
| mobile_p704x480 | 150 | 26.883126 | 33.978324 | 40.345346 | 46.451883 |
| SOCCER_704x576_30_orig_02 | 255 | 31.795858 | 38.263099 | 44.445286 | 50.428366 |
| starwars17clean_720x480. | 100 | 36.704894 | 43.131189 | 49.196297 | 55.006248 |
| CREW_704x576_30_orig_01.yuv | 255 | 32.620265 | 39.432153 | 45.577077 | 51.283966 |
| HARBOUR_704x576_30_orig_01.yuv | 255 | 28.050781 | 35.381261 | 41.913565 | 47.961625 |
| tennis_p704x480.yuv | 150 | 28.644174 | 36.018527 | 42.476728 | 48.493588 |
| fire_p720x480.YUV | 99 | 35.02409 | 41.570398 | 47.685407 | 53.350462 |
| Average PSNR (dB) | | 31.786099 | 38.441995 | 44.593477 | 50.475205 |

The preferred embodiments may be modified in various ways while retaining one or more of the features of compression/decompression of reference frames within a video coding loop.

What is claimed is:

1. A method of video coding for reducing memory size and external memory access bandwidth in video coding, wherein the method compresses a reference frame prior to storing the reference frame to memory.

2. The method of claim 1, wherein the compression is MMSQ.

3. The method of claim 1, wherein the compression is variable length coding with constraints on motion vector length.

4. An apparatus for video coding for reducing memory size and external memory access bandwidth in video coding, wherein the method compresses a reference frame prior to storing the reference frame to memory.

5. The apparatus of claim 4, wherein the compression is MMSQ.

6. The apparatus of claim 4, wherein the compression is variable length coding with constraints on motion vector length.

7. A computer readable medium comprising instructions when executed perform a method of video coding for reducing at least one of memory size or external memory access bandwidth in video coding, wherein the method compresses a reference frame prior to storing the reference frame to memory.

8. The computer readable medium of claim 7, wherein the compression is MMSQ.

9. The computer readable medium of claim 7, wherein the compression is variable length coding with constraints on motion vector length.
